(19) United States
(12) Patent Application Publication
(10) Pub. No.: US 2004/0105949 A1
(43) Pub. Date: Jun. 3, 2004

(54) Plastic-metal composite article

(76) Inventor: Frank Krause, Bergisch Gladbach (DE)

Correspondence Address: BAYER POLYMERS LLC, 100 BAYER ROAD, PITTSBURGH, PA, 15205, US

(21) Appl. No.: 10/722,017

(22) Filed: Nov. 24, 2003

(30) Foreign Application Priority Data
Jan. 17, 2003 (DE) 103 01 520.5
Nov. 29, 2002 (DE) 102 55 826.4

(51) Int. Cl. B32B 3/00

(52) U.S. Cl. 428/57

(57) ABSTRACT

A plastic-metal composite article that includes a first shaped metal part (1) and a second shaped metal part (2) that are joined in an overlap region (23) is described. Each of the first and second shaped metal parts have an overlap region (23) defined by a portion of the second shaped metal part (2) that is superposed over a portion of the first shaped metal part (1),

The first and second shaped metal parts are fixedly attached one to the other by: an adhesive (3) interposed between the first and second shaped metal parts in the overlap region (23); and thermoplastic material (4) that is molded onto at least a portion of the overlap region (23). The first (1) and second (2) shaped metal parts are substantially free of direct contact with each other in the overlap region (23). The adhesive also provides an electrically insulating layer between the first and second shaped metal parts in the overlap region.

### CROSS REFERENCE TO RELATED PATENT APPLICATION

The present patent application claims the right of priority under 35 U.S.C. §119 (a)-(d) of German Patent Application No. 103 01 520.5, filed Nov. 29, 2002.

### FIELD OF THE INVENTION

The present invention relates to a plastic-metal composite article (or constructional element), which is formed from at least two metallic shaped parts which are connected to one another by positive closure by means of molded-on thermoplastic material, and an interposed adhesive layer.

### BACKGROUND OF THE INVENTION

Composite constructional elements or semi-finished products that are used in practice consist, for example, of planar composites in which, for example, two metal sheets are connected with the aid of an intermediate plastic or plastic foam so as to form a sandwich structure (e.g., EP 489 320 A). Moreover, a process for producing composite panels with exterior metal sheets and interior ribbed structure is described in EP 775 573 A, for example. Furthermore, a process for connecting metal sheets through a combination of pressing and injection molding in a tool is described in EP 721 831 A. EP 370 342 A additionally describes plastic/metal composite constructional elements in which metal sheets are supported by ribbed structures.

EP 1 163 992 A discloses plastic/metal composite constructional elements which consist, in particular, of durable and rigid metal components such as steel, for example, which with the aid of a thermoplastic material are joined, held in position, galvanically separated from one another and preferably additionally supported by supporting structures in the form of ribs or solid walls. The thermoplastic material on the one hand connects the metallic shaped parts to one another by positive closure, and on the other hand forms an electrically insulating layer between the metallic shaped parts. These composite constructional elements find application, for example, in vehicle construction and mechanical engineering. If in this connection use is made of shaped parts formed from different metals, corrosion can be avoided by virtue of the thermoplastic material, since the shaped parts do not contact one another directly.

According to EP 1 163 992 A, plastic/metal composite constructional elements are produced by two or more metal shaped parts being put into an injection-molding tool and kept spaced apart and subsequently by the junction-point of the metal shaped parts in the injection-molding tool being entirely or partially encapsulated with thermoplastic material by injection molding, said thermoplastic material filling out the space between the metal shaped parts.

A disadvantage of such plastic/metal composite constructional elements, as summarized above, relates to the fact that by virtue of the layer of thermoplastic material the metal shaped parts exhibit a relatively large spacing from one another, within the range from greater than 1 mm to 3 mm. In addition, when the plastic/metal composite constructional elements are produced by means of injection molding there is the problem that the metal shaped parts which are kept spaced apart in the injection-molding tool are deformed relatively easily by virtue of the high injection pressure of the thermoplastic material. As a result of the deformation, contact of the different metal shaped parts, and therefore corrosion, can occur.

An object of the present invention includes providing plastic-metal composite constructional elements that do not exhibit such disadvantages as described previously herein.

### SUMMARY OF THE INVENTION

In accordance with the present invention, there is provided a plastic-metal composite article (20) comprising,

at least one first shaped metal part (1) and at least one second shaped metal part (2), each of said first and second shaped metal parts having an overlap region (23) defined by a portion of said second shaped metal part being superposed over a portion of said first shaped metal part,

wherein said first and second shaped metal parts are fixedly attached one to the other by

an adhesive (3) interposed between said first and second shaped metal parts in said overlap region, and

thermoplastic material (4) molded onto at least a portion of said overlap region,

further wherein said first and second shaped metal parts are substantially free of direct (or abutting) contact with each other in said overlap region, and said adhesive provides an electrically insulating layer between said first and second shaped metal parts in said overlap region.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions, such as those expressing structural dimensions, quantities of ingredients, etc. used in the specification and claims are understood as modified in all instances by the term “about.”

### BRIEF DESCRIPTION OF THE DRAWINGS

FIG. 1 is a representative perspective view of a plastic-metal composite article (20) according to the present invention;

FIG. 2 is a partially exploded perspective view of the plastic-metal composite article of FIG. 1, in the absence of reinforcing struts (7);

FIG. 3 is a representative section view of the plastic-metal composite article of FIG. 1 along line A-A;

FIG. 4 is a graphical representation of a plot of force versus deformation displacement that represents the mechanical loadability of a plastic-metal composite article according to the present invention (13) relative to a comparative plastic-metal composite article (14) having no interposed adhesive layer; and

FIG. 5 is a representative sectional view of the plastic-metal composite article of FIG. 1 along line A-A.

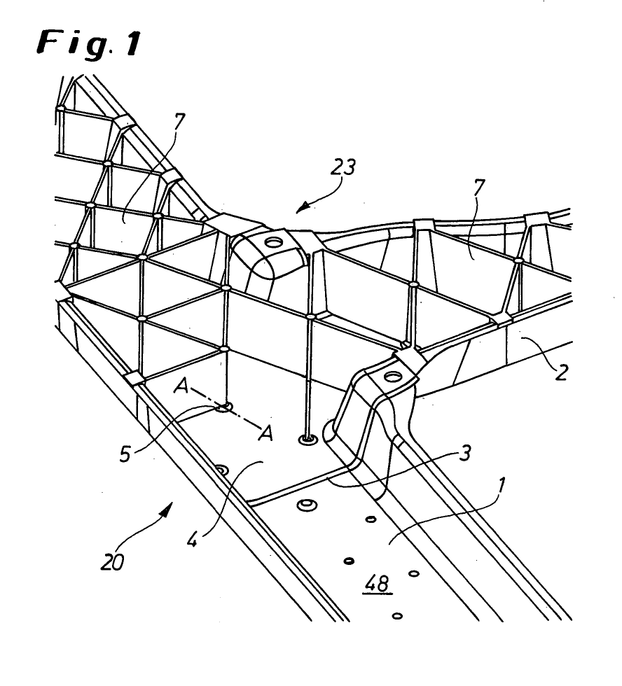

In FIGS. 1 through 5, like reference numerals designate the same components and structural features.

### DETAILED DESCRIPTION OF THE INVENTION

The present invention accordingly provides a plastic-metal composite constructional element formed from at least two metallic shaped parts which, in overlapping regions of the shaped parts, form a material closure with an interposed adhesive layer and are additionally connected to one another by molded-on thermoplastic material (in the overlap region). The shaped metal parts have substantially no direct (or abutting) contact with one another in the overlap region, and the adhesive provides an electrically insulating layer between the shaped parts in the overlap region.

The metallic shaped parts are each independently fabricated from the same or different metals and/or metal alloys. In an embodiment of the present invention, the first and second shaped metal parts each independently comprise a metal selected from steel, nickel, chromium, copper, zinc, titanium, aluminum, magnesium, and alloys thereof.

The adhesive of the adhesive layer that is interposed between the first and second shaped metal parts may be selected from one-component polyurethane adhesives, two-component polyurethane adhesives, one-component epoxy resin adhesives, two-component epoxy resin adhesives, cyanoacrylate adhesives, silicone adhesives and combinations thereof. Two-component polyurethane adhesives that may be used typically include a active hydrogen functional component comprising polyols, such as diols and/or triols, and optionally polyamines, in particular of polyether polyols or polyester polyols, and an isocyanate function component comprising, for example, aromatic and/or aliphatic di- and/or poly-isocyanates. Two-component polyurethane adhesives are typically mixed together and reacted in place, i.e., in the overlap region. One-component polyurethane adhesives are typically the reaction product of polyols and diisocyanates and/or polyisocyanates, optionally with excess isocyanate functionality relative to the active hydrogen functionality (e.g., hydroxyl groups). One-component polyurethane adhesives, are typically used in the form of a hot-melt adhesive (reactive hot melt) or in the pasty to liquid state. One-component epoxy-resin adhesives include those that are the reaction product of epichlorohydrin and o-cresol and/or phenol novolaks ( )polycondensation products prepared from formaldehyde and phenols by acid catalysis). Two-component epoxy-resin adhesives that may be used typically include an epichlorohydrin component and a polyhydric phenol component such as, bisphenol A. Cyanoacrylate adhesives that may be used, include those based on monomeric 2-cyanoacrylic esters. Silicone adhesives that may be used include polyorganosiloxanes, in particular silicone rubbers based on crosslinked polydiorganosiloxanes.

The adhesive typically has a layer thickness from 0.05 mm to less than 1 mm (e.g., from 0.05 mm to 0.8 mm or from 0.05 mm to 0.9 mm). Preferably the adhesive layer has thickness from 0.1 mm to 0.5 mm.

A significant advantage of the plastic-metal composite constructional element according to the invention consists in the fact that a layer of adhesive between the metal shaped parts in the overlap region allows for the use of a thinner adhesive layer thickness, and therefore smaller spacings of the metal shaped parts from one another. A comparative plastic-metal composite constructional element in which the shaped metal parts are connected solely by means of an injected layer of interposed thermoplastic material in the overlap region, requires a thicker layer of interposed thermoplastic material than the interposed adhesive layer of the present invention. In the present invention, the connection of the metal shaped parts by means of a combination of molded-on plastic and an interposed layer of adhesive in the overlap region, has the advantage (relative to a material-closure connection solely by means of an adhesive layer) of a lower peel stress of the adhesive bond when exposed to loads. Finally, the composite constructional element according to the present invention has a higher mechanical loadability relative to comparative plastic-metal composite constructional elements that have no adhesive bond between the metal shaped parts in the overlap region.

In a preferred embodiment of the present invention, the adhesive interposed between the first and second shaped metal parts in the overlap region comprises spacers. The spacers serve to maintain a desired separation between the first and second shaped metal parts in the overlap region. In particularly preferred embodiment, the spacers are substantially spherical in shape, and are fabricated from a material selected from glass, ceramic, plastic material (i.e., thermoplastic material and/or thermosetting plastic material) and combinations thereof. Plastic materials from which the spacers may be fabricated, include for example, polyamide (PA), polyester, in particular polyethylene terephthalate (PET), polybutylene terephthalate (PBT), polyolefin, in particular polypropylene (PP), polyethylene (PE), styrene/acrylonitrile copolymer, in particular acrylonitrile/styrene/butadiene copolymer (ABS), polycarbonate (PC), polypropylene oxide (PPO), polysulfone (PSO), polyphenylene sulfide (PPS), polyimide (PI), polyether ether ketone (PEEK), phenolic resin, urea resins, melamine resins or epoxy resins.

The spacers: (i) prevent the metal shaped parts from being so severely deformed by the high pressures associated with the injection of the thermoplastic material in the course of production of the composite constructional element (by means of injection molding); and (ii) prevent the adhesive from being so greatly compressed that a contact arises between the different metal shaped parts.

The spacers preferably have a thickness (e.g., an average thickness) from 0.05 mm to 1 mm, a thickness from 0.1 mm to 0.5 mm being particularly preferred. If the spacers are spheres, the diameter (e.g., average diameter) preferably amounts to from 0.05 mm to 1 mm, a diameter from 0.1 mm to 0.5 mm being particularly preferred. The spacers that are introduced into a layer of adhesive preferably have the same thickness or the same diameter. However, it is also possible to introduce spacers having different thicknesses or diameters, for example if the spacing between the two metallic shaped parts is to be larger or smaller at certain points on the composite constructional element.

In addition to the material-closure connection by means of a layer of adhesive, the connection of the metallic shaped parts is effected by virtue of molded-on thermoplastic material. In a preferred embodiment of the present invention, each of the first and second shaped metal parts ( and 2) have bores (36 and 33) having edges (39 and 42). At least some of the bores (33) of the second shaped metal part (2) are at least partially aligned with and superposed over at least some of the bores (36) of the first shaped metal part (1) and together define aligned bores (30) having edges. The thermoplastic material that is molded onto at least a portion of the overlap region (23) extends through at least some of the aligned bores (30), the edges (39 and 42) of the aligned bores are embedded in the thermoplastic material extending there through, thereby fixedly (and irreversibly) anchoring (or attaching) the thermoplastic material to at least a portion of the overlap region (23). More particularly, the thermoplastic material extending through the aligned bores (30) serves to fixedly attach the molded-on plastic (4) to the first and second shaped metal parts in the overlap region.

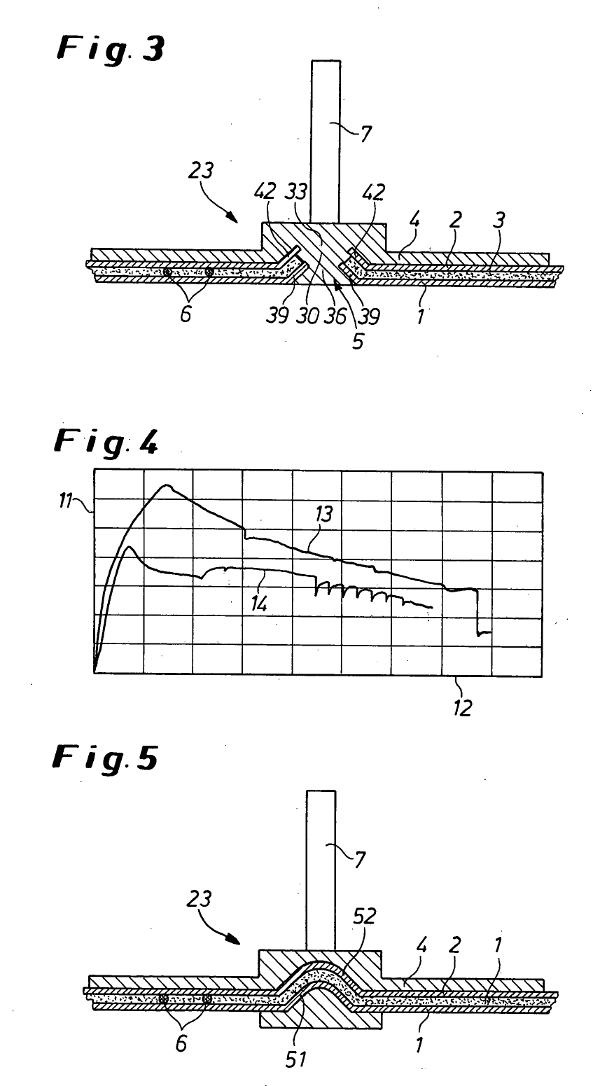

The first and second shaped metal parts in the overlap region may each independently have bores having deformed and/or undeformed edges or edge portions. Undeformed edges are substantially straight (e.g., they are neither bent nor beveled). Deformed edges of the bores may be, for example bent, crimped and/or beveled. Bores 36 and 33 in FIG. 3 have deformed edges 39 and 42 respectively, and accordingly aligned bore 30 has or is defined by deformed bore edges 39 and 42.

In a further preferred embodiment of the present invention, the first and/or second shaped metal parts, in the overlap region, further comprises deformations selected from at least one of beads and bulges. At least some of the deformations are embedded in the thermoplastic material molded onto at least a portion of the overlap region, and thereby further fixedly anchor the thermoplastic material to at least a portion of the overlap region. The deformations may be present, in the overlap region, in the absence of or in addition to the aligned bores.

The first and second shaped metal parts may each independently have closed and/or open profiles. If the first and/or second shaped metal parts have open profiles (48 and 45), additional reinforcing struts (7) formed from a thermoplastic material may be provided abutingly within the profiles. The thermoplastic material of the reinforcing struts is preferably the same plastic as that of the thermoplastic material molded-onto the overlap region for the purpose of connecting the two shaped metal parts. Alternatively, the plastic of the reinforcing struts and the thermoplastic material molded-onto the overlap region for the purpose of connecting the two shaped metal parts may be different thermoplastic materials.

In an embodiment of the present invention, each of the first (1) and second (2) shaped metal parts have an open profile (48, 45), and the article (20) further includes molded-on thermoplastic reinforcing struts (7).that are positioned abutingly within the open profiles of each of the first and second shaped metal parts. The molded-on thermoplastic reinforcing struts are preferably continuous with the thermoplastic material molded onto at least a portion of said overlap region.

By way of thermoplastic material for the connection of the metallic shaped parts and also, optionally, for the additional reinforcing struts, use is made of an unreinforced or reinforced, or filled plastic based on polyamide (PA), polyester, in particular polyethylene terephthalate (PET), polybutylene terephthalate (PBT), polyolefin, in particular polypropylene (PP), polyethylene (PE), styrene/acrylonitrile copolymer, in particular acrylonitrile/styrene/butadiene copolymer (ABS), polycarbonate (PC), polypropylene oxide (PPO), polysulfone (PSO), polyphenylene sulfide (PPS), polyimide (PI), polyether ether ketone (PEEK) or a possible mixture of these plastics.

Reinforcing materials that may be included in the thermoplastic material of the reinforcing struts and/or the thermoplastic material molded onto at least a portion of the overlap region include, but are not limited to, glass fibers, carbon fibers, metal fibers, polyamide fibers (e.g., KEVLAR polyamide fibers) and mixtures thereof. Fillers that may be included in the thermoplastic material of the reinforcing struts and/or the thermoplastic material molded onto at least a portion of the overlap region include, but are not limited to, talc, calcium carbonate and barium sulfate. The reinforcing fibers, and the glass fibers in particular, may have sizings on their surfaces to improve miscibility and/or adhesion to the plastics into which they are incorporated, as is known to the skilled artisan. Glass fibers are a preferred reinforcing material in the present invention. If used, the reinforcement material, e.g., glass fibers, is typically present in the thermoplastic materials of the reinforcing struts and/or the molded-on thermoplstic material in a reinforcing amount, e.g., in an amount of from 5 percent by weight to 60 percent by weight, based on the total weight of thermoplstic reinforcing struts and/or the molded-on thermoplstic material.

The thermoplastic materials of the reinforcing struts and/or the molded-on thermoplstic material may each independently further contain one or more functional additives. Additives that may be used include, but are not limited to, antioxidants, colorants, e.g., pigments and dyes, mold release agents, ultraviolet light absorbers, fire retardants and mixtures thereof. Additives may be present in functionally sufficient amounts, e.g., in amounts independently from 0.1 percent by weight to 10 percent by weight, based on the total weight of the thermoplastic material.

In the production of the plastic-metal composite constructional element according to the present invention, in a first step one of the first and second shaped metal parts is provided with a layer of adhesive in the overlap region of the shaped parts. Alternatively, both the first and second shaped metal parts may be provided with adhesive in the overlap region. The spacers may be introduced into the layer of adhesive by, for example, addition to the adhesive prior to application. The adhesive is preferably applied over the full surface(s) of the first and/or second shaped metal parts that face each other in and define the overlap region. Subsequently the shaped parts are put into an injection-molding tool with the adhesive interposed and pressed abutingly between the overlap region of the first and second shaped metal parts. Thermoplastic material is injected into the mold and at least a portion of the overlap region is encapsulated with thermoplastic material, and optionally at least a portion of the first and/or second shaped metal parts are encapsulated with injected thermoplastic material in areas other than the overlap region.

If use is made of open metal profiles (48 and 45), additional reinforcing struts may be formed in the profiles prior to, concurrently with and/or subsequent to the thermoplastic material molded onto the overlap region. Since the joining process is achieved via a thermal reshaping of the molded-on thermoplastic component, the shrinkage of the thermoplastic material can be utilized for the purpose of building up stresses which provide for a permanent and durable composite in the region of the overlap region (or junction-point) of the shaped metal parts. Compared with a sole adhesive bond of separate metal shaped parts, the additional connection of the shaped metal parts by means of molded-on thermoplastic material in the course of production has the advantage that the adhesive hardens more quickly by virtue of the heat that is introduced in the course of molding on step. Therefore the composite constructional elements can be loaded at an earlier stage. A further advantage in the course of production of the composite constructional element according to the invention consists in the fact that, by virtue of the mechanical connection by means of molded-on plastic, an initial strength is achieved that is not obtained during hardening in the case of a sole (or lone) adhesive bond.

Moreover, further additional elements that fulfil mechanical functions, such as, for example, the supporting of additional panels or girders, the fastening of parts to be fitted later, or the accommodation of further constructional elements, may be integrated into the composite constructional element. These integrated elements may be produced, on the one hand, with the aid of further elements inserted by positive closure and formed from highly durable materials and, on the other hand, by molding on beads, recesses or screw domes by means of a thermoplastic component.

The composite constructional element according to the invention will be elucidated in more detail below with reference to the drawing figures.

### EXAMPLES

### Example 1

FIG. 1 shows a plastic-metal hybrid joint (overlap region 23) formed from two sheet-metal profiles 1, 2 and a ribbed thermoplastic structure 7, as well as an adhesive layer 3 between the two sheet-metal profiles 1, 2. The sheet-metal profiles 1, 2 are fabricated from different metals: the metal of profile 1 is steel; the metal of profile 2 is aluminum. Alternatively, the composite constructional element 20 could also be constructed from a metal profile 1 made of steel, and a metal profile 2 made of magnesium, for example. In order to avoid (or substantially eliminate) electrolytic corrosion, the connection of the different metal parts is effected in such a way that the metal profiles do not directly contact (or abut) one another directly. The connection is effected, on the one hand, via the molded-on thermoplastic material 4. To this end, the metal sheets 1 and 2 have bores (holes) (36 and 33—see FIG. 3) each having a flanged edge (39 and 42) which have been punched in identical positions and which accommodate a cast-on spigot and form a rivet-head joint 5 (or attachment head). On the other hand, the connection of the different metal parts is effected by means of the adhesive layer 3 which forms a separation layer between the metal sheets 1 and 2 for the additional purpose of avoiding electrolytic corrosion. The ribbed thermoplastic structure 7 provides for the stiffening of the sheet-metal profiles 1, 2.

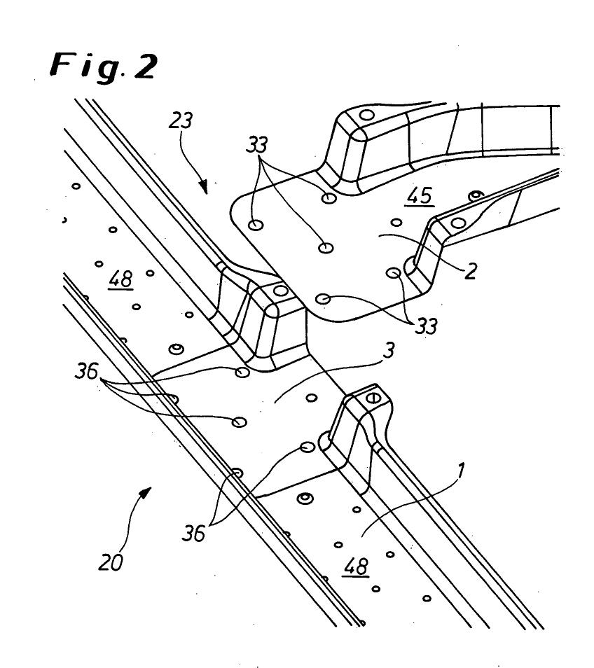

FIG. 2 shows the sheet-metal profiles 1, 2 prior to connection to the adhesive layer 3. In the embodiment that is represented, the adhesive layer 3 has been applied onto the metal profile 1. Alternatively, the adhesive layer 3 may also be applied onto the metal profile 2, or onto both metal profiles 1,2.

FIG. 3 shows a section A-A through the plastic-metal composite constructional element from FIG. 1 with the rivet-head joint 5. Spheres 6 made of glass have been incorporated into the adhesive layer 3 and act as spacers. The rivet-head joint 5, which is formed by the molded-on thermoplastic material, forms an undercut with the flanged bores in the metal profiles 1, 2. This prevents the displacement of the metal profiles 1 and 2 relative to one another during the hardening phase of the adhesive 3.

FIG. 5 shows a section A-A through the plastic-metal composite constructional element from FIG. 1 with beads 51, 52 in the metal profiles 1, 2. Spheres 6 made of glass have been incorporated into the adhesive layer 3 and act as spacers. The beads 51, 52 in the overlap region are aligned. They are embedded in the thermoplastic material 4 molded onto at least a portion of the overlap region, and thereby further fixedly anchor (or attach) the thermoplastic material 4 to at least a portion of the overlap region. This prevents the displacement of the metal profiles 1 and 2 relative to one another during the hardening phase of the adhesive 3.

### Example 2

A plastic-metal composite constructional element 20 according to the invention, as represented in FIG. 1, was compared in respect of mechanical loadability with a plastic-metal composite constructional element of substantially identical construction which, however, had no adhesive bond between the two metal shaped parts in overlap region 23. The mechanical loadability was determined as follows: the composite constructional elements were loaded to bending, by the two ends of the metallic shaped part 1 being firmly clamped. At the free end of the shaped part 2, which is placed substantially perpendicular to the shaped part 1, a force was introduced. The force acted substantially perpendicular to the shaped part 2 in the plane spanned by the two shaped parts 1,2.

FIG. 4 shows a diagram that represents the force (ordinate 11) as a function of the deformation displacement (abscissa 12). It shows the force/displacement curves of the two composite constructional elements: curve 13 corresponds to the composite constructional element 20 according to the invention; while curve 14 corresponds to a comparative plastic/metal composite constructional element having no adhesive layer. The deformation force of the composite constructional element according to the invention is about 48% greater than that of the comparative composite constructional element having no interposed adhesive layer in the overlap region 23.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A plastic-metal composite article comprising,
at least one first shaped metal part and at least one second shaped metal part, each of said first and second shaped metal parts having an overlap region defined by a portion of said second shaped metal part being superposed over a portion of said first shaped metal part,
wherein said first and second shaped metal parts are fixedly attached one to the other by
an adhesive interposed between said first and second shaped metal parts in said overlap region, and
thermoplastic material molded onto at least a portion of said overlap region,
further wherein said first and second shaped metal parts are substantially free of direct contact with each other in said overlap region, and said adhesive provides an electrically insulating layer between said first and second shaped metal parts in said overlap region.

2. The plastic-metal composite article of claim 1 wherein said first and second shaped metal parts are each fabricated from at least one of different metals and different metal alloys.

3. The plastic-metal composite article of claim 1 wherein said first and second shaped metal parts each independently comprise a metal selected from steel, nickel, chromium, copper, zinc, titanium, aluminum, magnesium, and alloys thereof.

4. The plastic-metal composite article of claim 1 wherein said adhesive has a thickness of from 0.05 mm to 1 mm.

5. The plastic-metal composite article of claim 1 wherein said adhesive is selected from one-component polyurethane adhesive, two-component polyurethane adhesive, one-component epoxy resin, two-component epoxy resin, cyanoacrylate adhesive, silicone adhesive and combinations thereof.

6. The plastic-metal composite article of claim 1 wherein said adhesive comprises spacers.

7. The plastic-metal composite article of claim 6 wherein said spacers are substantially spherical and are fabricated from a material selected from glass, ceramic, thermoplastic material, thermosetting material and combinations thereof.

8. The plastic-metal composite article of claim 1 wherein in said overlap region each of said first and second shaped metal parts have bores having edges, at least some of said bores of said second shaped metal part are aligned with and superposed over at least some of said bores of said first shaped metal part and together define aligned bores having edges, said thermoplastic material molded onto at least a portion of said overlap region extending through at least some of said aligned bores, the edges of said aligned bores being embedded in the thermoplastic material extending there through, thereby fixedly anchoring the thermoplastic material to at least a portion of said overlap region.

9. The plastic-metal composite article of claim 8 wherein the edges of said aligned bores are deformed edges.

10. The plastic-metal composite article of claims 1 or 8 wherein in said overlap region at least one of said first shaped metal part and said second shaped metal part further comprises deformations selected from at least one of beads and bulges, at least some of said deformations being embedded in the thermoplastic material molded onto at least a portion of said overlap region, thereby further fixedly anchoring the thermoplastic material to at least a portion of said overlap region.

11. The plastic-metal composite article of claim 1 wherein each of said first and second shaped metal parts have an open profile, said article further comprising molded-on thermoplastic reinforcing struts that are positioned abutingly within the open profiles of each of said first and second shaped metal parts, and said molded-on thermoplastic reinforcing struts being continuous with the thermoplastic material molded onto at least a portion of said overlap region.

12. The plastic-metal composite article of claim 1 wherein the thermoplastic material molded onto at least a portion of said overlap region comprises a polymer selected from polyamide, polyester, polyolefin, styrene/acrylonitrile copolymer, polycarbonate, polypropylene oxide, polysulfone, polyphenylene sulfide, polyimide, polyether ether ketone and combinations thereof.

13. The plastic-metal composite article of claim 12 wherein the thermoplastic material molded onto at least a portion of said overlap region comprises a polymer selected from polyethylene terephthalate, polybutylene terephthalate, polypropylene, polyethylene, acrylonitrile/styrene/butadiene copolymer, and combinations thereof.

14. The plastic-metal composite article of claim 12 wherein said thermoplastic material molded onto at least a portion of said overlap region further comprises at least one of reinforcing materials and filler materials.
